(19) United States
(12) Patent Application Publication
(10) Pub. No.: US 2019/0152342 A1
(43) Pub. Date: May 23, 2019

(54) Method of Energizing Electric Vehicle Power Train with Multiple and Independently Controlled Battery Packs

(71) Applicants: Fang SHEN, Shanghai (CN); Hua SHUI, Shanghai (CN); Jie CHEN, Shanghai (CN)

(72) Inventors: Fang SHEN, Shanghai (CN); Hua SHUI, Shanghai (CN); Jie CHEN, Shanghai (CN)

(21) Appl. No.: 16/254,560

(22) Filed: Jan. 22, 2019

Related U.S. Application Data
(63) Continuation-in-part of application No. 15/249,356, filed on Aug. 27, 2016.

(51) Int. Cl. B60L 58/18; H02J 7/00; B60L 50/60; H01M 2/10; H01M 2/20; H01M 10/42

(52) U.S. Cl. CPC B60L 58/18; H02J 7/0013; B60L 50/60; H01M 2/1077; H01M 2010/4271; H01M 10/425; B60L 2240/547; H01M 2220/20; H01M 2/206

(57) ABSTRACT

A power system for an electric vehicle comprising a battery pack connector unit and a battery assembly. The battery pack connector unit is electrically connected to a motor driver controller, and comprises at least a first battery connector and a second battery connector. The battery assembly includes at least a first battery pack and a second battery pack controlled by a first battery management system and a second battery management system respectively. When the first battery pack is electrically connected to the first battery connector, the first battery management system is arranged to become a master battery management system which is adapted to control the second battery management system as a slave battery management system, in such a manner that a respective voltage output of the battery assembly is optimally modulated by the master battery management system so as to create a single voltage output of the power system.

### CROSS REFERENCE OF RELATED APPLICATION

This is a Continuation-In-Part application of a non-provisional application having an application number of Ser. No. 15/249,356 and a filing date of Aug. 27, 2016.

### BACKGROUND OF THE PRESENT INVENTION

### Field of Invention

The present invention relates to the field of electric vehicle technology, whose power train is energized by one or multiple battery packs.

### Description of Related Arts

While electric cars are gaining more popularities, electric vehicle mileage has also been the most important concern for consumers because of their limited driving range stemming from their limited battery energy, which is further exacerbated by the weight of the vehicle.

Meanwhile, electric vehicle charging facilities are lacking and charging speed is also a concern. As a result, there is a great need and market to have the ability to increase the electric vehicle driving ranges by consumers.

As shown in FIG. 1 of the drawings, an electric vehicle normally has three major parts in its power train 1P, namely one or multiple electric motors 1P, one or multiple motor driver controllers 2P, and one battery pack 3P.

The battery pack 3P is normally installed in one battery enclosure box. Sometimes the battery pack 3P may be installed in multiple battery enclosure boxes. But these boxes will operate as one battery pack, which means that individual boxes have to be connected together to energize the EV's power train under one BMS control to charge/discharge together.

In this arrangement, a single battery pack is formed normally by connecting multiple battery modules. All battery modules are to be connected together so to operate as one battery pack, and managed by a single battery management system and one control unit and a Charger/Discharger Port. In short, all battery modules function together as a single battery pack.

### SUMMARY OF THE PRESENT INVENTION

Certain variations of the present invention provide a power system for a power train of an electric vehicle, which may be energized by one or multiple battery packs so as to allow a user the flexibility of mounting the right number of battery packs depending on the needs of planned distance and weight of electric vehicle.

Certain variations of the present invention provide a power system for an electric vehicle in which a master battery management system is capable of controlling a plurality of slave battery management systems so that different output voltages of the battery packs may be optimally modulated to form a single output voltage for the electric vehicle.

In one aspect of the present invention, it provides a power system for an electric vehicle comprising a power train which comprises a motor controlled by a motor driver controller, the power system comprising:

a battery pack connector unit electrically connected to the motor driver controller, the battery pack connector unit comprising at least a first battery connector and a second battery connector; and

a battery assembly comprising at least a first battery pack and a second battery pack, the first battery back being controlled by a first battery management system, the second battery pack being controlled by a second battery management system, wherein when the first battery pack is electrically connected to the first battery connector, the first battery management system is arranged to become a master battery management system which is adapted to control the second battery management system as a slave battery management system, in such a manner that a respective voltage output of the battery assembly is optimally modulated by the master battery management system so as to create a single voltage output of the power system for the power train of the electric vehicle.

This summary presented above is provided merely to introduce certain concepts and not to identify any key or essential features of the claimed subject matter.

### BRIEF DESCRIPTION OF THE DRAWINGS

FIG. 1 is a schematic diagram of a conventional power train for an electric vehicle, illustrating an architecture of the relationship between a motor/drive controller, a battery pack, and a motor.

FIG. 2 is a schematic diagram of a power train for an electric vehicle according to a first preferred embodiment of the present invention.

FIG. 3 is another schematic diagram of a power train with multiple battery packs for an electric vehicle according to a first preferred embodiment of the present invention, illustrating the relationship between a battery pack controller, multiple battery packs including one master battery pack and several slave battery packs, and a battery pack connector unit.

FIG. 4 is another schematic diagram of a power train with multiple battery packs for an electric vehicle according to a first preferred embodiment of the present invention, illustrating the relationship between a BMS, a Unit controller and battery modules.

FIG. 5 is a schematic diagram of a power train for an electric vehicle, illustrating an architecture of the relationship between a motor, a drive controller, a battery pack, and a motor according to a second preferred embodiment of the present invention.

FIG. 6 is a schematic diagram of a power train for an electric vehicle according to the second preferred embodiment of the present invention.

FIG. 7 is another schematic diagram of a power train with multiple battery packs for an electric vehicle according to the second first preferred embodiment of the present invention.

FIG. 8 is schematic diagram of a main connector circuitry and control and allocation circuitries according to the second first preferred embodiment of the present invention.

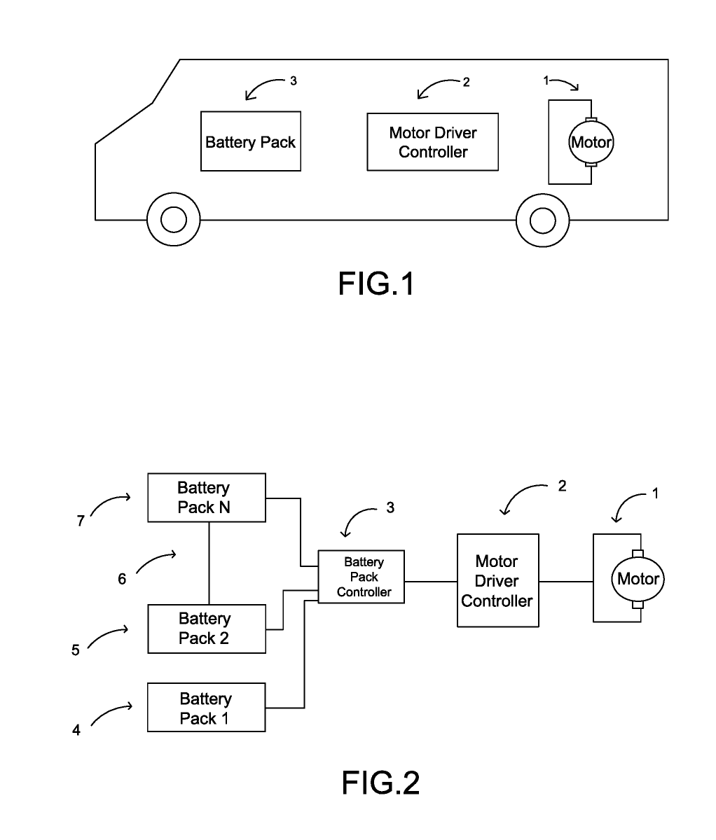

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

Referring to FIG. 2 to FIG. 4 of the drawings, EV motor 1 is connected to the motor drive controller 2. In the first preferred embodiment, the motor depicted in 1 can be multiple motors for front and back transmission.

Referring to FIG. 2, the motor drive controller 2 is connected to the battery packs 3 and EV motor 1.

Referring to FIG. 2, the battery pack 3 is connected to the motor drive controller 2.

Referring to FIG. 2, in the first preferred embodiment, EV motor 1 is connected to the motor drive controller 2.

Referring to FIG. 2, in the first preferred embodiment, the motor drive controller 2 is connected to the battery pack controller 3.

Referring to FIG. 2, in the first preferred embodiment, the battery packs 3 to 7 are connected to the battery pack controller 2. N in 7 means any undetermined integer number large than 2.

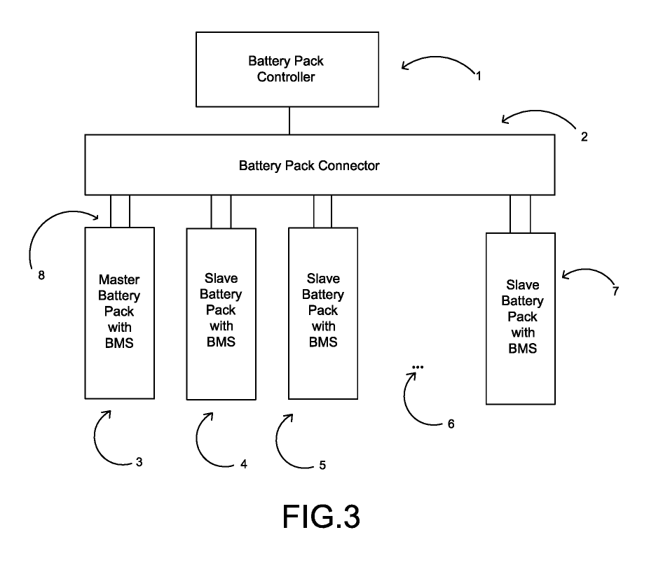

Referring to FIG. 3, in the first preferred embodiment, the battery pack controller 1 is connected to the battery pack connector unit.

Referring to FIG. 3, in the first preferred embodiment, the software in the battery pack controller 1 is sourced from the BMS software of the master battery pack. In another embodiment, the software in the battery pack controller 1 is sourced externally from the interface of the battery pack controller.

Referring to FIG. 3, in the first preferred embodiment, the battery pack connector unit 2 allows connection of a master battery pack and slave battery packs.

Referring to FIG. 3, in the first preferred embodiment, the master battery pack 3 is connected to the battery pack connector unit using the master battery pack position in the battery connector 8. The master battery pack has its own battery management system software.

Referring to FIG. 3, in the first preferred embodiment, the slave battery pack 4 is connected to the battery pack connector unit using one of the slaver battery pack position. The slaver battery pack 4 has its own battery management system software.

Referring to FIG. 3, in the first preferred embodiment, the slave battery pack 5 is connected to the battery pack connector unit using one of the slaver battery pack position. The slaver battery pack 5 has its own battery management system software.

Referring to FIG. 3, in the first preferred embodiment, the dots 6 indicate that there are many slave battery pack positions depending on the physical dimension of the battery pack connector unit.

Referring to FIG. 3, in the first preferred embodiment, the slave battery pack 7 is connected to the battery pack connector unit using the last slaver battery pack position. The slaver battery pack 7 has its own battery management system software.

Referring to FIG. 3, the battery connector 8 prevent installation of a battery pack into the master battery slot or the slave battery slot if the polarity of insertion is incorrect.

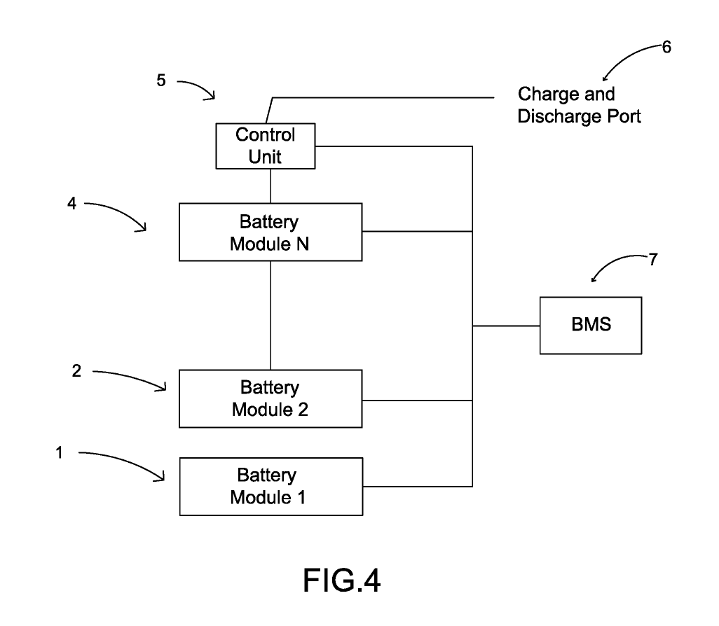

Referring to FIG. 4, it shows a battery pack comprises multiple battery modules, all under the control of a single BMS and battery unit control. FIG. 4 shows an example schematic diagram of the implementation within one battery pack in the state of art of EV power train system.

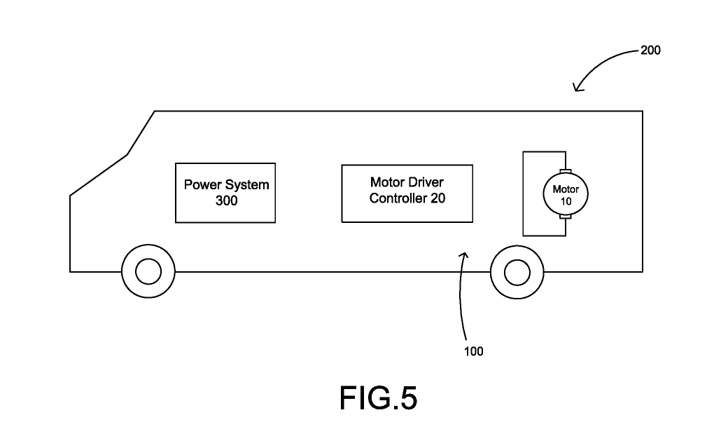

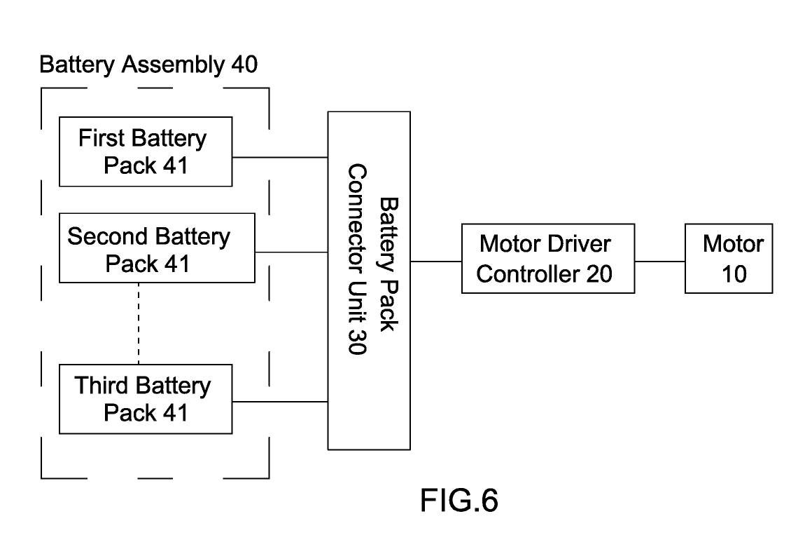

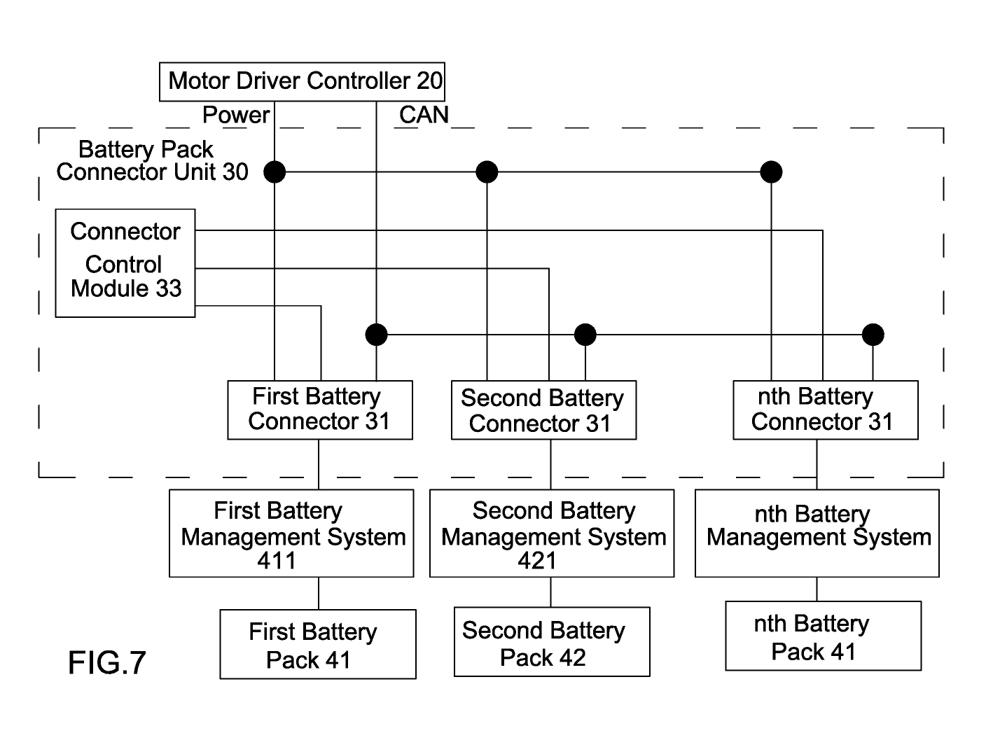

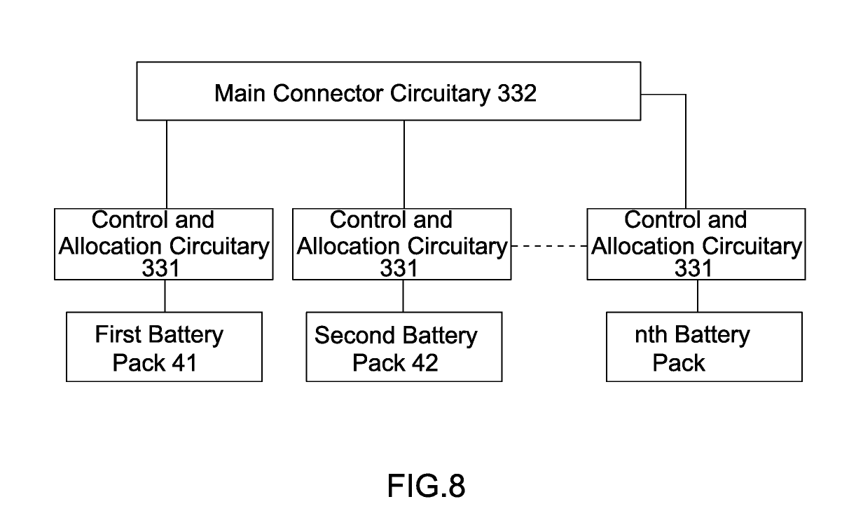

Referring to FIG. 5 to FIG. 8 of the drawings, a power system for an electric vehicle 200 (EV) having a power train 100 according a second preferred embodiment of the present invention is illustrated. The power system 300 may be primarily for use in an EV having a power train 100. The power train 100 may comprise a motor 10, a motor driver controller 20 connected to the motor 10. The power system 300 of the present invention may be electrically connected to the motor driver controller 20. Broadly, the power system 300 of the present invention may comprise a battery pack connector unit 30 and a battery assembly 40.

The battery pack connector unit 30 may be electrically connected to the motor driver controller 20. The battery pack connector unit 30 may comprise at least a first battery connector 31 and a second battery connector 32.

The battery assembly 40 may comprise at least a first battery pack 41 and a second battery pack 42. The first battery back 41 may be controlled by a first battery management system 411. The second battery pack 42 may be controlled by a second battery management system 412. When the first battery pack 41 is electrically connected to the first battery connector 31, the first battery management system 411 is arranged to become a master battery management system which is adapted to control the second battery management system 412 as a slave battery management system, in such a manner that a respective voltage output of the battery assembly 40 may be optimally modulated by the master battery management system so as to create a single voltage output of the power system 300 for the power train 100 of the electric vehicle 200.

According to the second preferred embodiment of the present invention, the battery pack connector unit 30 may comprise a plurality of battery connectors. The first battery connector 31 and the second battery connector 32 mentioned above represent the minimum number of battery connectors for illustrating the operation of the present invention. The exact number of battery connectors depend on manufacturing and operation circumstances of the present invention.

The battery pack connector unit 30 may further comprise a connector control module 33 electrically connected to the first battery connector 31 and the second battery connector 32, or other battery connectors if they exist. The connector control module 33 may comprise a main connector circuitry 332, and a plurality of control and allocation circuitries 331 which is specifically programmed to allocate battery pack identification for each of the first battery pack 41 and the second battery pack 42 when they are connected to the first battery connector 31 and the second battery connector 32 respectively. Thus, the connector control module 33 may assign and allocate battery pack identification to the battery packs connected to the battery connectors respectively. For the sake of convenience, the connector control module 33 may comprise a first control and allocation circuitry 331 and a second control and allocation circuitry 332 for electrically connecting to the first battery lack 41 and the second battery pack 42 respectively.

As mentioned above, each of the battery packs may be controlled by a corresponding battery management system. Thus, the first battery back 41 may be controlled by a first battery management system 411. The second battery pack 42 may be controlled by a second battery management system 412. A feature of the present invention is that when a battery pack is connected to a designated battery connector (such as the first battery connector 31), the corresponding battery management system will become a master battery management system. The battery management systems of other battery packs which are connected to other battery connectors will become slave battery management systems. The master battery management system is arranged to control and manage all other slave battery management systems.

Thus, when there is only one master battery management system (i.e. the first battery management system 411) and one slave battery management system (i.e. the second battery management system 412), the first battery management system 411 may be arranged to control the second battery management system 412 through the connector control module 33. This is in contrast with conventional arts in which each battery pack is controlled by an individual battery management system. Each of the battery management systems can only control a corresponding battery and has nothing to do with other battery management systems.

Each of the battery packs, such as the first battery pack 41 and the second battery pack 42, may have a corresponding control and allocation circuitry 331 programmed to allocate a battery identification to the corresponding battery pack. For example, the first battery pack 41 and the corresponding first battery management system 411 may be electrically connected to the first control and allocation circuitry 331 while the second battery pack 42 and the corresponding second battery management system 421 may be electrically connected to the second control and allocation circuitry 332. When the battery packs are electrically connected to the battery connectors respectively, the battery identification of each of the battery packs may be individually allocated.

The operation of the present invention is as follows: the battery assembly 40 may comprise a plurality of battery packs, such as the first battery pack 41 and the second battery pack 42 described above. One of the battery packs, such as the first battery pack 41, may be connected to the first battery connector 31 of the battery pack connector unit 30 and assigned a specific battery identification. The first battery management system 411 of the first battery pack 41 will become the master battery management system because of the specifically assigned battery identification assigned to the first battery pack 41, while the second battery management system 412 will become the slave battery management system. Each of the battery management systems may be electrically connected to the corresponding control and allocation circuitry 331. The master battery management system may centrally control charging and discharging of all of the battery packs. In other words, all slave battery management systems can only be controlled by the master battery management system. According to the preferred embodiment of the present invention, the first battery management system 411 being the master battery management system may communicate with other slave battery packs such as the second battery management system 412 of the second battery pack 42 via Controller Area Network (CAN), while the master battery management system also gets the status information from the slave battery management system such as the second battery management system 412 in a real time manner via CAN.

With such a central control, the master battery management system may be programmed to determine the optimal level of power usage of the electric vehicle 200 when all travel parameters are provided. Moreover, the master battery management system may direct charging of the master battery pack and the all of the slave battery packs. The master pack can control the input and output of the slave battery packs based on the information from the slave battery packs. The slave battery pack can control energy input and output through its internal relay. In this second preferred embodiment of the present invention, the master battery pack can control voltage input and voltage output of a single slave battery pack such as the second battery pack 42 mentioned above, or the voltage inputs or outputs of multiple slave battery packs simultaneously.

According to the second preferred embodiment of the present invention, both the master battery pack (such as the first battery pack 41) and all the slave battery packs (such as the second battery pack 42) may be removed from or inserted to the battery pack connector unit 30 without regards to the switch status of other battery packs.

The present invention, while illustrated and described in terms of a preferred embodiment and several alternatives, is not limited to the particular description contained in this specification. Additional alternative or equivalent components could also be used to practice the present invention.

What is claimed is:

1. A power system for an electric vehicle comprising a power train which comprises a motor controlled by a motor driver controller, said power system comprising:
a battery pack connector unit electrically connected to said motor driver controller, said battery pack connector unit comprising at least a first battery connector and a second battery connector; and
at battery assembly comprising at least a first battery pack and a second battery pack, said first battery back being controlled by a first battery management system, said second battery pack being controlled by a second battery management system, wherein when said first battery pack is electrically connected to said first battery connector, said first battery management system is arranged to become a master battery management system which is adapted to control said second battery management system as a slave battery management system, in such a manner that a respective voltage output of said battery assembly is optimally modulated by said master battery management system so as to create a single voltage output of said power system for said power train of said electric vehicle.

2. The power system, as recited in claim 1, wherein said battery pack connector unit further comprises a connector control module electrically connected to said first battery connector and said second battery connector, said connector control module comprises a main connector circuitry, and a first control and allocation circuitry and a second control allocation circuitry specifically programmed to allocate battery pack identification for said first battery pack and said second battery pack respectively.

3. The power system, as recited in claim 2, wherein said master battery management system is configured to determine an optimal level of power usage of said electric vehicle so as to allow said battery assembly to deliver a single voltage output to said power train of said electric vehicle.

4. The power system, as recited in claim 3, wherein said master battery management system is configured to control charging and discharging of said first battery pack and said second battery pack.

5. The power system, as recited in claim 3, wherein said battery pack connector unit further comprises a plurality of battery connectors while said battery assembly further comprises a plurality of battery packs electrically connected to said battery connectors respectively, wherein each of said battery packs is controlled by a battery management system which becomes a slave battery management system and is controlled by said master battery management system.

6. The power system, as recited in claim 4, wherein said battery pack connector unit further comprises a plurality of battery connectors while said battery assembly further comprises a plurality of battery packs electrically connected to said battery connectors respectively, wherein each of said battery packs is controlled by a battery management system which becomes a slave battery management system and is controlled by said master battery management system.

7. The power system, as recited in claim 5, wherein each of said battery packs is selectively detachable from said battery pack connector unit without interfering operation of said remaining said battery packs.

8. The power system, as recited in claim 6, wherein each of said battery packs is selectively detachable from said battery pack connector unit without interfering operation of said remaining said battery packs.
